(19) United States
(12) Patent Application Publication
(10) Pub. No.: US 2018/0364382 A1
(43) Pub. Date: Dec. 20, 2018

(54) Similarity Determination based on a Coherence Function

(71) Applicant: PGS Geophysical AS, Oslo (NO)

(72) Inventors: Maiza Bekara, Weybridge (GB); Christopher Mark Davison, Weybridge (GB)

(73) Assignee: PGS Geophysical AS, Oslo (NO)

(21) Appl. No.: 16/004,533

(22) Filed: Jun. 11, 2018

Related U.S. Application Data
(60) Provisional application No. 62/520,828, filed on Jun. 16, 2017.

(51) Int. Cl. G01V 1/36

(52) U.S. Cl. CPC G01V 1/36

(57) ABSTRACT

Determining a similarity based on a coherence function can include receiving a first set of seismic data and a second set of seismic data, generating a coherence function using the first and the second sets of seismic data, storing the coherence function, determining a similarity between the first and the second sets of the seismic data based on the generated coherence function, and based on the determined similarity, detecting a future error or absence of a future error associated with the first and the second sets of seismic data.

### CROSS-REFERENCE TO RELATED APPLICATIONS

This application claims priority to U.S. Provisional Application 62/520,828, filed Jun. 16, 2017, which is incorporated by reference.

### BACKGROUND

In the past few decades, the petroleum industry has invested heavily in the development of marine survey techniques that yield knowledge of subterranean formations beneath a body of water in order to find and extract valuable mineral resources, such as oil. High-resolution images of a subterranean formation are helpful for quantitative interpretation and improved reservoir monitoring. For a typical marine survey, a marine survey vessel tows one or more marine survey sources (hereinafter referred to as “sources”) below the sea surface and over a subterranean formation to be surveyed for mineral deposits. Marine survey receivers (hereinafter referred to as “receivers”) may be located on or near the seafloor, on one or more streamers towed by the marine survey vessel, or on one or more streamers towed by another vessel. The marine survey vessel typically contains marine survey equipment, such as navigation control, source control, receiver control, and recording equipment. The source control may cause the one or more sources, which can be impulsive sources such as air guns, non-impulsive sources such as marine vibrator sources, electromagnetic sources, etc., to produce signals at selected times. Each signal is essentially a wave called a wavefield that travels down through the water and into the subterranean formation. At each interface between different types of rock, a portion of the wavefield may be refracted, and another portion may be reflected, which may include some scattering, back toward the body of water to propagate toward the sea surface. The receivers thereby measure a wavefield that was initiated by the actuation of the source.

### BRIEF DESCRIPTION OF THE DRAWINGS

FIG. 1 illustrates an elevation or xz-plane view of marine surveying in which signals are emitted by a source for recording by receivers.

FIG. 2 illustrates a diagram of an exemplary embodiment of a system for a similarity determination based on a coherence function (CF).

FIG. 3 illustrates a diagram of an exemplary embodiment of a machine for a similarity determination based on a CF.

FIG. 4 illustrates an exemplary embodiment of a method flow diagram for a similarity determination based on a CF.

FIG. 5 illustrates a diagram of an amplitude portion of a CF against frequency plotted along a two-dimensional (2D) processing line.

FIG. 6 illustrates a diagram a phase portion of a CF against frequency plotted along a 2D processing line.

FIG. 7 illustrates a diagram of an amplitude portion of a CF against frequency plotted along a 2D processing.

FIG. 8A illustrates a diagram of seismic gathers prior to de-multiple.

FIG. 8B illustrates a diagram of seismic gathers subsequent to de-multiple.

### DETAILED DESCRIPTION

The present disclosure is related to determining a similarity between seismic data sets based on a coherence function (CF). For instance, a comparison can be made between the seismic data sets, and the comparison can be used to determine a quality of one of the seismic data sets or a process used in modeling one of the seismic data sets. Quality, as used herein, can include a standard of something as measured against other things of a similar kind or a degree of excellence of something such as a seismic data set or modeling process. As used herein, a seismic data set can include a seismic model or a set of data collected during marine surveying including, for instance seismic or electromagnetic (EM) surveying, among others. A seismic model can refer to a map of the subsurface associated with the collected seismic data at various locations in the subsurface. In at least one embodiment, a seismic data set can include a set of data collected during land surveying. Seismic data can comprise data associated with a wavefield. For instance, seismic data may include data associated with time, space, and amplitudes of wavefields. Received seismic data comprises sampled and/or recorded seismic data. Seismic data may be sampled from a seismic receiver located on a cable, an ocean bottom cable, or a node, among others.

Some prior approaches to determining a similarity between seismic data sets include determining a cross-correlation between individual traces. However, while cross-correlation determinations used in prior approaches can be used in determining a similarity between two objects, at least one embodiment of the present disclosure includes determining a similarity between a plurality of sets of seismic data. For instance, at least one embodiment of the present disclosure can include performing quality control (QC) on seismic data sets after a processing step, such as multiple modeling or adaptive multiple subtraction, which may be desired by producers and consumers of seismic data. As used herein, a similarity between seismic data sets or a plurality of sets of seismic data can include something associated with different seismic data sets that resemble one another but may not be identical.

For example, the effectiveness of a QC system can depend on usage of informative attributes and compression and visualization ability. As used herein, an informative attribute can include a measure, which can be numerical, that can be used to quantify QC. As used herein, compression ability can refer to the measure being used to identify locations of concern including poor quality data, poor quality models, or poor-quality processes within very large data sets. As used herein, visualization ability can refer to the measure being used to visually identify regions of poor quality through outlying values of the measure, which can stand out. At least one embodiment of the present disclosure can improve QC of seismic data sets subsequent to processing by using a frequency-dependent seismic data set-based attribute that can be used for a plurality of processing components including, for instance, multiple modeling and adaptive multiple subtraction. At least one embodiment can reduce a turnaround of production by performing QC with improved speed and accuracy. This, in turn improves an efficiency of a computing device participating in the QC process, as more efficient and improved processes may be run on the computing device. Failure risk can be identified, and re-run cost and time can be reduced. For instance, future errors with a data set or processing approach can be detected and prevented. As used herein, a future error can include a mistake or incorrect condition that can later reveal itself if not found in a current state. For example, a future error may be something identified in the seismic data or the seismic data problem that would cause a problem in the future. Detecting this future error solves a technical problem of QC in adaptive subtraction approaches by improving adaptive subtraction functioning because reruns can be avoided, for instance. Further detecting the future error solves a technical problem of QC in failure risk assessment by detecting future errors and resulting risk of failure. The risk of failure can be reduced as the rerun cost, production times, and processing times are reduced.

For instance, in at least one embodiment of the present disclosure, models and processing can be assessed by comparing seismic data sets. For example, a base seismic data set and a monitor seismic data set can be compared using a CF to determine a quality of the monitor data set. A seismic model can be compared to a base seismic data set to determine a quality of the seismic model. As used herein, when comparing the seismic model to the base seismic data set a base seismic data set can include a received set of seismic data that has not been processed. This can also be referred to as a “raw” seismic data set. A monitor seismic data set can be a seismic data set to be analyzed for future or current errors. In at least one embodiment, the monitor seismic data set has undergone some seismic processing.

When assessing the adaptive subtraction process, the base data set can include results of the adaptive subtraction, which can be seismic data with an adapted multiple model removed. For instance, this can include a difference between seismic data consisting of primaries and multiples, and data comprising the adapted multiple model, produced from the multiple model by adaption. The monitor data set in such an example can be the adapted multiple model.

A primary, as used herein, is a wavefield that has undergone only one reflection. A seismic data set or seismic model can include information associated with a primary, and the information in the seismic data set or seismic model can be referred to hereinafter as a primary or primaries.

As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

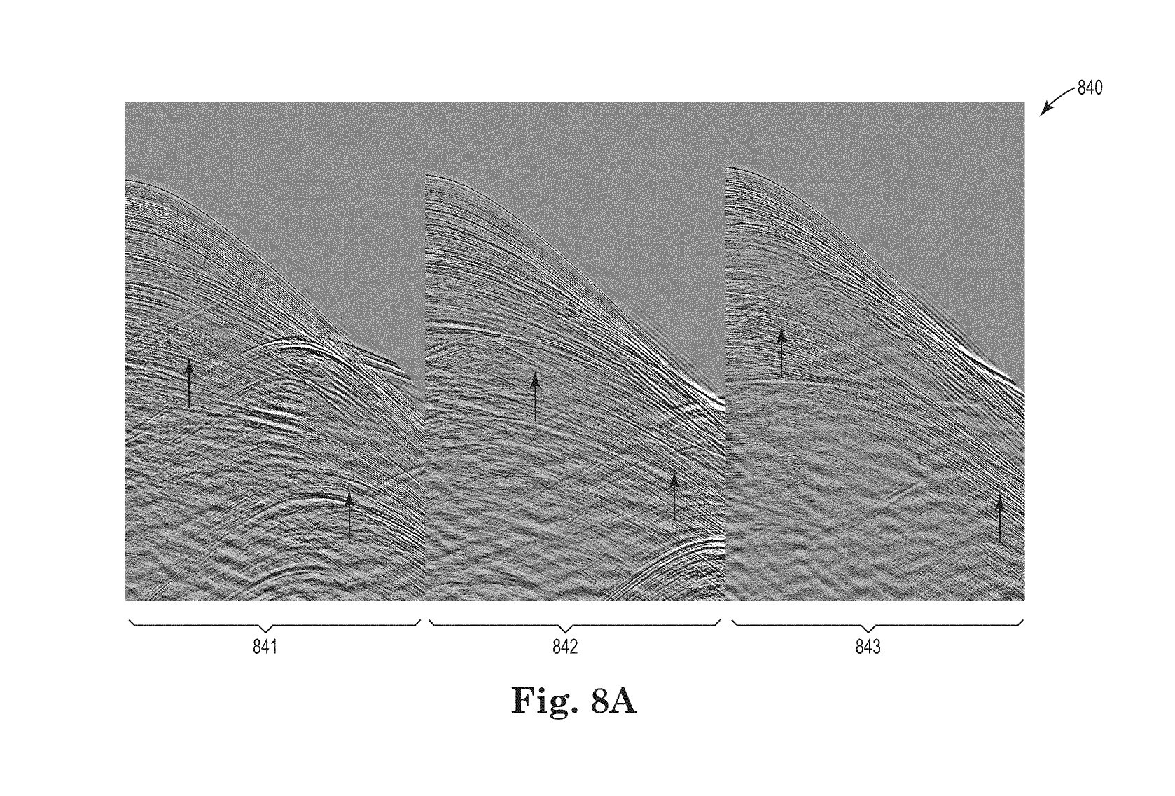

The figures herein follow a numbering convention in which the first digit or digits correspond to the drawing figure number and the remaining digits identify an element or component in the drawing. Similar elements or components between different figures may be identified by the use of similar digits. Analogous elements within a Figure may be referenced with a hyphen and extra numeral or letter. See, for example, elements 797-1 and 797-2 in FIG. 7. Such analogous elements may be generally referenced without the hyphen and extra numeral or letter. For example, elements 797-1 and 797-2 may be collectively referenced as 797. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention and should not be taken in a limiting sense.

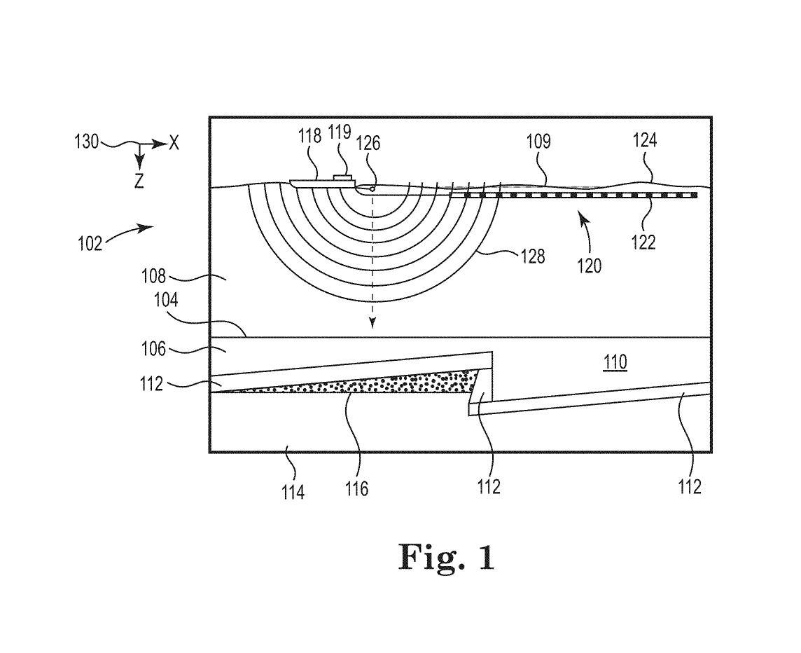

FIG. 1 illustrates an elevation or xz-plane 130 view of marine surveying in which signals are emitted by a source 126 for recording by receivers 122. The recording can be used for processing and analysis in order to help characterize the structures and distributions of features and materials underlying the surface of the earth. For example, the recording can be used to estimate a physical property of a subsurface location, such as the presence of a reservoir that may contain hydrocarbons. FIG. 1 shows a domain volume 102 of the earth's surface comprising a subsurface volume 106 of sediment and rock below the surface 104 of the earth that, in turn, underlies a fluid volume 108 of water having a sea surface 109 such as in an ocean, an inlet or bay, or a large freshwater lake. The domain volume 102 shown in FIG. 1 represents an example experimental domain for a class of marine surveys. FIG. 1 illustrates a first sediment layer 110, an uplifted rock layer 112, underlying rock layer 114, and hydrocarbon-saturated layer 116. One or more elements of the subsurface volume 106, such as the first sediment layer 110 and the uplifted rock layer 112, can be an overburden for the hydrocarbon-saturated layer 116. In some instances, the overburden may include salt.

FIG. 1 shows an example of a marine survey vessel 118 equipped to carry out marine surveys. In particular, the marine survey vessel 118 can tow one or more streamers 120 (shown as one streamer for ease of illustration) generally located below the sea surface 109. The streamers 120 can be long cables containing power and data-transmission lines (e.g., electrical, optical fiber, etc.) to which receivers may be coupled. In one type of marine survey, each receiver, such as the receiver 122 represented by the shaded disk in FIG. 1, comprises a pair of sensors including a geophone that detects particle displacement within the water by detecting particle motion variation, such as velocities or accelerations, and/or a receiver that detects variations in pressure. In one type of marine survey, each receiver, such as receiver 122, comprises an electromagnetic receiver that detects electromagnetic energy within the water. The streamers 120 and the marine survey vessel 118 can include sensing electronics and data-processing facilities that allow receiver readings to be correlated with absolute positions on the sea surface and absolute three-dimensional positions with respect to a three-dimensional coordinate system. In FIG. 1, the receivers along the streamers are shown to lie below the sea surface 109, with the receiver positions correlated with overlying surface positions, such as a surface position 124 correlated with the position of receiver 122.

The marine survey vessel 118 can tow one or more sources 126 that produce signals as the marine survey vessel 118 and streamers 120 move across the sea surface 109. Although not specifically illustrated, the sources 126 can include at least one marine impulsive source and at least one marine non-impulsive source. Sources 126 and/or streamers 120 may also be towed by other vessels or may be otherwise disposed in fluid volume 108. For example, receivers may be located on ocean bottom cables or nodes fixed at or near the surface 104, and sources 126 may also be disposed in a nearly-fixed or fixed configuration. For the sake of efficiency, illustrations and descriptions herein show receivers located on streamers, but it should be understood that references to receivers located on a “streamer” or “cable” should be read to refer equally to receivers located on a towed streamer, an ocean bottom receiver cable, and/or an array of nodes.

FIG. 1 shows acoustic energy illustrated as an expanding, spherical signal, illustrated as semicircles of increasing radius centered at the source 126, representing a down-going wavefield 128, following a signal emitted by the source 126. For ease of illustration and consideration with respect to the detail shown in FIG. 1, the down-going wavefield 128 may be considered as a combined output of both a marine impulsive source and a marine non-impulsive source. The down-going wavefield 128 is, in effect, shown in a vertical plane cross section in FIG. 1. The outward and downward expanding down-going wavefield 128 may eventually reach the surface 104, at which point the outward and downward expanding down-going wavefield 128 may partially scatter, may partially reflect back toward the streamers 120, and may partially refract downward into the subsurface volume 106, becoming elastic signals within the subsurface volume 106.

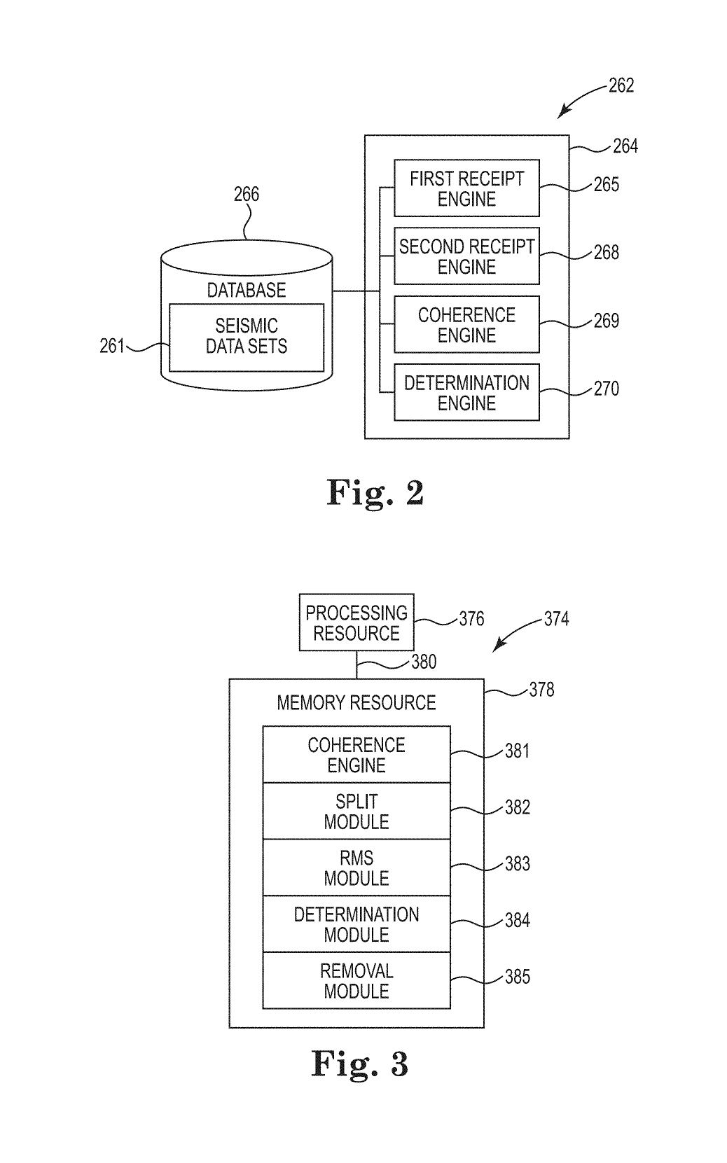

FIG. 2 illustrates a diagram of a system 262 for a similarity determination based on a CF. The system 262 can include a database 266, a subsystem 264, and/or a number of engines, such as a first receipt engine 265, a second receipt engine 268, a coherence engine 269, and a determination engine 270. The subsystem 264 can be analogous to the controller 119 illustrated in FIG. 1 in at least one embodiment. The subsystem 264 and engines can be in communication with the database 266 via a communication link. The database can store seismic data sets 261. The seismic data sets 261 can include a set of seismic gathers of data containing primaries and multiples, a set of seismic gathers of multiple models, a set of de-multipled data, or a multiple seismic model, among other seismic data sets.

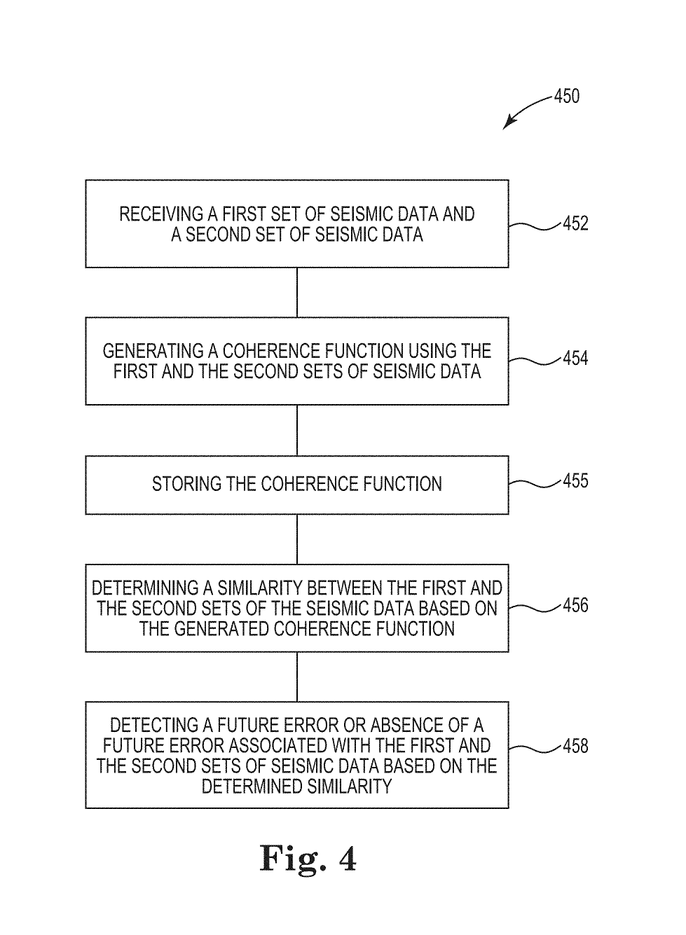

The system 262 can include more or fewer engines than illustrated to perform the various functions described herein. The system can represent program instructions and/or hardware of a machine such as the machine 374 referenced in FIG. 3, etc. As used herein, an “engine” can include program instructions and/or hardware, but at least includes hardware. Hardware is a physical component of a machine that enables it to perform a function. Examples of hardware can include a processing resource, a memory resource, a logic gate, etc.

The number of engines can include a combination of hardware and program instructions that is configured to perform a number of functions described herein. The program instructions, such as software, firmware, etc., can be stored in a memory resource such as a machine-readable medium, etc., as well as hard-wired program such as logic. Hard-wired program instructions can be considered as both program instructions and hardware.

The first receipt engine 265 can include a combination of hardware and program instructions that is configured to receive a set of seismic gathers of multiple models, and the second receipt engine 268 can include a combination of hardware and program instructions that is configured to receive a set of seismic gathers of de-multipled data. A seismic gather is a set of traces that share a geometric attribute. For example, a seismic gather can be a display of seismic traces, and a seismic trace can be a recorded curve resulting from a movement measurement. A set of seismic gathers can include a plurality of seismic gathers. In at least one embodiment, a set of seismic gathers of particular data such as primaries and multiples, multiple models, de-multipled data, or a multiple seismic model, can be referred to as a set of seismic gathers associated with the particular data. In at least one embodiment, it may be desired to compare the set of seismic gathers of multiple models to the set of seismic gathers of de-multipled data to detect a future error in either seismic data set. For instance, if the two seismic data sets are too similar, it may indicate that the de-multipled data does not have an ample amount of an associated multiple seismic model removed, and a future error can be detected and avoided by adjusting a seismic modeling process to better remove the associated multiple seismic model.

The seismic gathers of multiple model seismic gathers associated with predicted multiples can include raw multiple models or models adapted to seismic data, and in at least one embodiment, the set of seismic gathers of de-multipled data can include models of seismic data subsequent to adaptive subtraction of a multiple model. As used herein, a raw multiple model is a multiple model generated or predicted by a mathematical model of a physical process by which multiples are generated in a marine survey by a plurality of reflections of seismic waves. This can be modelled using input seismic data or other means. A raw multiple model may not exactly correlate to actual multiples within the seismic data. For instance, the raw multiple model may accurately represent them but may be at an incorrect scale or out of synchronization with the seismic data by a time shift. A model adapted to the seismic data can include a raw multiple model adapted to correspond to the multiples within the seismic data that can be subtracted from the seismic data to leave primaries. A time shift, as used herein, can include a movement from one time period to another.

In at least one embodiment, two seismic data sets including a set of seismic gathers of multiple models, which can include raw or adapted-to seismic data and a set of seismic gathers of de-multipled data can be used to generate a CF. As used herein, de-multipled data is seismic data that has undergone adaptive subtraction of an associated multiple model. As used herein, a multiple model is a model of multiples associated with seismic data. A multiple is a wavefield that has undergone more than one reflection. Thus, de-multipled data is data that has had multiples removed therefrom or reduced therein. Adaptive subtraction, as used herein, can include making a subtraction process suitable to conditions of a prediction and original seismic data. Adaptive subtraction is an element used in data-driven multiple-suppression methods to minimize misalignments and amplitude differences between predicted and actual multiples and can reduce multiple contaminations in a data set after subtraction. For instance, adaptive subtraction can include subtracting a seismic model from a first set of seismic data including the seismic model and a primary.

A CF, as used herein, is a function to determine a similarity, which may also be described as a coherence, between signals. For instance, in at least one embodiment of the present disclosure, given two sets of seismic data xₖ(t) and yₖ(t), where k is an integer index running from 1 to a positive integer N, a CF can be expressed as:

$${γ}_{xy} ( f ) = \frac{{\sum }_{k = 1}^{N} {X}_{k} ( f ) {Y}_{k}^{*} ( f )}{\sqrt{( {\sum }_{k = 1}^{N} {X}_{k} ( f ) {X}_{k}^{*} ( f ) ) ( {\sum }_{k = 1}^{N} {Y}_{k} ( f ) {Y}_{k}^{*} ( f ) )}} ,$$

where f=frequency, Xₖ(f)=the Fourier transform of xₖ(f), “*” indicates a complex conjugate, and Yₖ(f)=the Fourier transform of yₖ(t).

The CF can be a measure that can be used to judge a degree of similarity between two seismic data sets. As a complex number, it may be split into an amplitude portion and a phase portion. The amplitude portion of the CF can be a real number with a value between zero and one and can give a normalized measure of similarity between two sets of signals, which in at least one embodiment of the present disclosure are seismic data sets, as a function of frequency. A value of zero can mean that the two seismic data sets are independent, and a value of one can mean that the two seismic data sets are identical or can mean that one data set is a scaled factor of the other data set. Increased values in a particular range can indicate a closer similarity between the two seismic data sets. In at least one embodiment, the amplitude portion can be a probability that the two seismic data sets are the same. The phase portion of the CF is a measure of a time shift between two similar seismic data sets.

The coherence engine 269 can include a combination of hardware and program instructions that is configured to generate a coherence function using the set of seismic gathers of multiple models and the set of seismic gathers of de-multipled data and including a phase portion and an amplitude portion of the CF, and the determination engine 270 can include a combination of hardware and program instructions that is configured to determine a similarity between the set of seismic gathers of multiple models and the set of seismic gathers of de-multipled data based on the generated CF. For instance, a desired outcome of the comparison using the CF may be that the seismic gathers of multiple models and the set of seismic gathers of de-multipled data have CF amplitude portion near zero. For instance, the seismic gathers of multiple models can include a primary. Upon applying adaptive subtraction to de-multiple, a desired result may be the primary alone as a result, meaning little similarity may exist between the two seismic data sets. However, if upon application of the generated CF, multiples remain in the de-multipled set of seismic data, there may be an error in the adaptive subtraction process.

Accordingly, based on the similarity determination, a determination of a quality of a process used to de-multiple the seismic data can be made, and a determination of a quality of the adaptive subtraction process can be made. For instance, if it is determined that multiple residuals are present in the de-multipled data or that primary leakage occurred during the de-multiple process, it may be determined that the de-multiple process or the adaptive subtraction process (if they are different) should be adjusted for better results. For instance, in at least one embodiment, system 262 can include an adjustment engine (not illustrated in FIG. 2) including a combination of hardware and program instructions that is configured to adjust a parameterization of an associated adaptive subtraction of the multiple model using the generated CF. A de-multiple process, as used herein, is a process during which data is de-multipled as described herein.

Parameterization includes expressing a model in terms of numerical parameters and adjusting the numerical parameters associated with an adapted multiple model. For instance, in adaptive subtraction, a multiple model can be adapted to seismic data containing both primaries and multiples to create an adapted multiple model, and the adapted multiple model can be subtracted from the seismic data. The adaption can include a mathematical algorithm which, in addition to the two data sets, can require a plurality of numerical parameters that control how the algorithm works. By adjusting the parameters, a better or worse adapted model can be achieved, which can lead to a better or worse de-multiple process. For instance, it may be desirable to choose a set of parameters to give the best de-multiple process. In at least one embodiment, the CF can be used to adjust the parameters in order to achieve a set that results in as near to a best de-multiple as possible.

For example, when using the CF as a QC of the de-multiple process or adaptive subtraction process, results of the CF can indicate regions of seismic data sets where there may be potential residual multiple or primary leakage. As the CF indicates a similarity between seismic data sets, where there may be a case of residual multiple, the similarity of the seismic data sets can increase as part of the removed multiple can still be present in an output subsequent to adaptive subtraction. Similarly, for an example of primary leakage, the similarity based on the CF can increase as part of the primary may be present in the subtracted multiples. Determining these regions can be used to detect and prevent future errors with the seismic data sets or processes associated therewith. At least one embodiment of the similarity detection can be used in four-dimensional seismic data processing.

FIG. 3 illustrates a diagram of a machine 374 for a similarity determination based on a CF. The machine 374 can utilize software, hardware, firmware, and/or logic to perform a number of functions. The machine 374 can be a combination of hardware and program instructions configured to perform a number of functions and/or actions. The hardware, for example, can include a number of processing resources 376 and a number of memory resources 378, such as a machine-readable medium or other non-transitory memory resources 378. The memory resources 378 can be internal and/or external to the machine 374, for example, the machine 374 can include internal memory resources and have access to external memory resources. The program instructions, such as machine-readable instructions, can include instructions stored on the machine-readable medium to implement a particular function. The set of machine-readable instructions can be executable by one or more of the processing resources 376. The memory resources 378 can be coupled to the machine 374 in a wired and/or wireless manner. For example, the memory resources 378 can be an internal memory, a portable memory, a portable disk, and/or a memory associated with another resource, for example, enabling machine-readable instructions to be transferred and/or executed across a network such as the Internet. As used herein, a “module” can include program instructions and/or hardware, but at least includes program instructions.

Memory resources 378 can be non-transitory and can include volatile and/or non-volatile memory. Volatile memory can include memory that depends upon power to store data, such as various types of dynamic random-access memory among others. Non-volatile memory can include memory that does not depend upon power to store data. Examples of non-volatile memory can include solid state media such as flash memory, electrically erasable programmable read-only memory, phase change random access memory, magnetic memory, optical memory, and/or a solid-state drive, etc., as well as other types of non-transitory machine-readable media.

The processing resources 376 can be coupled to the memory resources 378 via a communication path 380. The communication path 380 can be local or remote to the machine 374. Examples of a local communication path 380 can include an electronic bus internal to a machine, where the memory resources 378 are in communication with the processing resources 376 via the electronic bus. Examples of such electronic buses can include Industry Standard Architecture, Peripheral Component Interconnect, Advanced Technology Attachment, Small Computer System Interface, Universal Serial Bus, among other types of electronic buses and variants thereof. The communication path 380 can be such that the memory resources 378 are remote from the processing resources 376, such as in a network connection between the memory resources 478 and the processing resources 376. That is, the communication path 380 can be a network connection. Examples of such a network connection can include a local area network, wide area network, personal area network, and the Internet, among others.

As shown in FIG. 3, the machine-readable instructions stored in the memory resource 378 can be segmented into a number of modules 381, 382, 383, 384, and 385 that when executed by the processing resource 376 can perform a number of functions. As used herein a module includes a set of instructions included to perform a particular task or action. The number of modules 381, 382, 383, 384, and 385 can be sub-modules of other modules. For example, the coherence module 381, split module 382, and RMS module 383 can be sub-modules of the determination module 384. Furthermore, the number of modules 381, 382, 383, 384, and 385 can comprise individual modules separate and distinct from one another. Examples are not limited to the specific modules 381, 382, 383, 384, and 385 illustrated in FIG. 3.

Each of the number of modules 381, 382, 383, 384, and 385 can include program instructions and/or a combination of hardware and program instructions that, when executed by a processing resource 376, can function as a corresponding engine as described with respect to FIG. 2. For example, the coherence module 381 can include program instructions and/or a combination of hardware and program instructions that, when executed by a processing resource 376, can function as the first receipt engine 265, the second receipt engine 268, and the coherence engine 269. In at least one embodiment, the split module 382 and the RMS module 383 can include program instructions and/or a combination of hardware and program instructions that, when executed by a processing resource 376, can function as the coherence engine 269. The determination module 384 and the removal module 384 can include program instructions and/or a combination of hardware and program instructions that, when executed by a processing resource 376, can function as the determination engine 270.

In at least one embodiment, the coherence module 381 can include instructions executed by processing resource 376 to generate a CF for a first set of seismic gathers comprising seismic data containing primaries and multiples and a second set of seismic gathers comprising multiple models over a seismic survey. The CF, as discussed previously, can be a measure that can be used to judge a degree of similarity between two seismic data sets. For instance, the CF can be generated for two sets of corresponding seismic gathers, which can include the first set of seismic gathers and the second set of seismic gathers. In at least one embodiment, the first set of seismic gathers can include a base set of seismic gathers, and the second set of seismic gathers can include a model or monitor set of seismic gathers. A monitor set of seismic gathers is a set of seismic gathers to be analyzed for future or current errors. In at least one embodiment, the monitor set of seismic gathers has undergone some seismic processing. A base set of seismic gathers is a received set of seismic gathers that has not been processed. This can also be referred to as a “raw” set of seismic gathers. For instance, it may be desired to compare the first and the second sets of seismic gathers to determine the quality of a particular model. In such an example, if the first set of seismic data includes received raw data, and the second set of seismic data includes seismic models of the raw data, a CF amplitude portion of one may be desired, indicating the seismic model is accurate and is a good representation of the raw data. However, a CF amplitude portion of zero may indicate an inaccurate seismic model. This information can be used to detect future errors in the seismic data collection process, the seismic data itself, or the modeling process, among other errors.

In at least one embodiment, split module 382 can include instructions executed to split the generated CF into a phase portion and an amplitude portion. The phase portion can indicate a time shift between the first set of seismic gathers and the second set of seismic gathers, and the amplitude portion can indicate a similarity between the first set of seismic gathers and the second set of seismic gathers. A plurality of seismic domains can be used for processing including, but not limited to, common shot domain, common receiver domain, common mid-point domain, and common channel domain, among others.

In at least one embodiment, root mean square (RMS) module 383 can include instructions executed to generate a plurality of RMS values over a predetermined frequency range based on the amplitude portion of the CF. For instance, the predetermined frequency range includes RMS values over an entire frequency range or a set of frequency ranges such as a set of frequency octaves. An octave can refer to an interval between one frequency and its double or its half. The RMS values can be plotted as a function of position to identify areas of the survey where there may be issues with the model, seismic data sets, or a portion of the seismic data processing. In at least one embodiment, frequency octaves can be used to identify a particular frequency range in which the issues may be present. An issue can include a problem that may be unwelcome or harmful and, in at least one embodiment, an issue can include an error or indicate a future error. For instance, an issue can prompt investigation into what may have caused the issue and how a future error can be prevented or avoided, for instance.

In at least one embodiment, frequency slices of the CF amplitude portion can be plotted, and a predetermined threshold can be set above or below a particular amplitude. That particular amplitude may indicate a point at which the amplitude portion of the CF being above can indicate a potential issue or falling below can indicate a potential issue. As used herein, a frequency slice is a plot of the CF at a constant frequency. In at least one embodiment, the plot can be over one or more spatial dimensions. The threshold level can be extracted from seismic data in the CF domain using statistical techniques such as histogram bounds, for instance.

Determination module 384 can include instructions executed by processing resource 476 to determine a dissimilar portion of seismic data gathered during the seismic survey based on the RMS values and the amplitude portion. For instance, the dissimilar portion can be the regions of the survey where issues may be present. For instance, having identified these regions, plots of the amplitude portion and the phase portion of the CF with respect to frequency along a line in the region indicated by the plots as having issues can be examined to provide additional information to localize the issues further. For example, the plots of CF along the line can be used to indicate individual seismic gathers of seismic data where there may be issues. As used herein, a line can include a particular number of source actuations in a same direction.

In at least one embodiment, removal module 385 can include instructions executed to remove the dissimilar portion from the seismic data. For instance, the dissimilar portion can be narrowed down to an individual seismic gather prior to removal. In such an example, the survey can be processed, and individual seismic gathers, where issues from a particular seismic data process may be present, can be automatically removed. As used herein, “automatically” can include being removed with limited or no user input and/or with limited or no prompting. For instance, the portion can be removed in response to a determination of a region having a dissimilar portion, and thus the removal is said to be automatic.

In at least one embodiment, the second set of seismic data can be adaptively subtracted from the first set of seismic data using the CF as a set of data weights as a numerical measure of quality of the first set of seismic data. For instance, in at least one embodiment, the CF generated between a seismic data set and a seismic model, either as it is or after further processing, can be used as a set of data weights which can be used in the process of adaptive subtraction of the seismic model from the seismic data. This can include, for example, adaptive subtraction of a multiple model from seismic data in a de-multiple process. The CF can be used in this example to update a parameterization of the adaptive subtraction process, which can be in octave panels, to reduce an amount of residual multiples or primary leakage.

As used herein, a data weight is a numerical measure of the quality of the seismic data. Data may be contaminated with noise. In at least one embodiment of the present disclosure, the data weights can be a set of real numbers between zero and one, where zero means that the data values are all noise, and one means that the data is uncontaminated. Values between zero and one can give a level of confidence in the data. When a mathematical inversion is performed to extract a model from seismic data, the inversion can be weighted such that it places more emphasis on the uncontaminated seismic data and less emphasis on seismic data contaminated by noise. The contaminated seismic data can have a tendency to introduce errors in an extracted model. The weighting can be performed by including a set of data weights, if they are available, in the inversion.

In at least one embodiment where an initial raw model is adapted to some seismic data, a least squares inversion process can be used, and a set of data weights, as a numerical measure of quality of the seismic data, can be incorporated into the inversion to positively reinforce contributions made by those data points that are accurate, while dampening contributions made by those data points that are less accurate or contaminated by noise. The application of data weights in inversion is not limited to least squares inversion, but can apply to other types of inversion including, for instance, sparse inversion or inversion using L¹, or Cauchy, among other norms. The CF, in at least one embodiment, can be used to classify a type of residual multiple to determine a post de-multiple solution. For instance, in an application of de-multiple, the CF can be used to classify residual multiples as diffracted high frequency, low frequency, or broadband, among others.

In at least one embodiment where more than one set of multiple models is generated from seismic data using different processes or in another embodiment when the same technique is used with a different model parameterization, the CF can be calculated between seismic data and a multiple model. A comparison between the CFs between the two situations can be used to indicate where each model is better or worse than the other. In at least one embodiment, the CF can be generated where the two seismic data sets include one multiple model and a different multiple model, to assess a level of similarity between the two models.

In at least one embodiment, the plots of the phase portion of the CF including frequency slices mapped against position in the survey, RMS values, or the CF phase portion plotted for all frequencies along a line, can be used in seismic QC. For example, the phase portion of the CF can be used to indicate a time shift between corresponding pairs of seismic data sets and seismic data sets comprising seismic models. This phase portion can be used to indicate issues with a seismic model, for example, where accurate model data seismic gathers may be at an incorrect time shift or shifts from a corresponding data seismic gather.

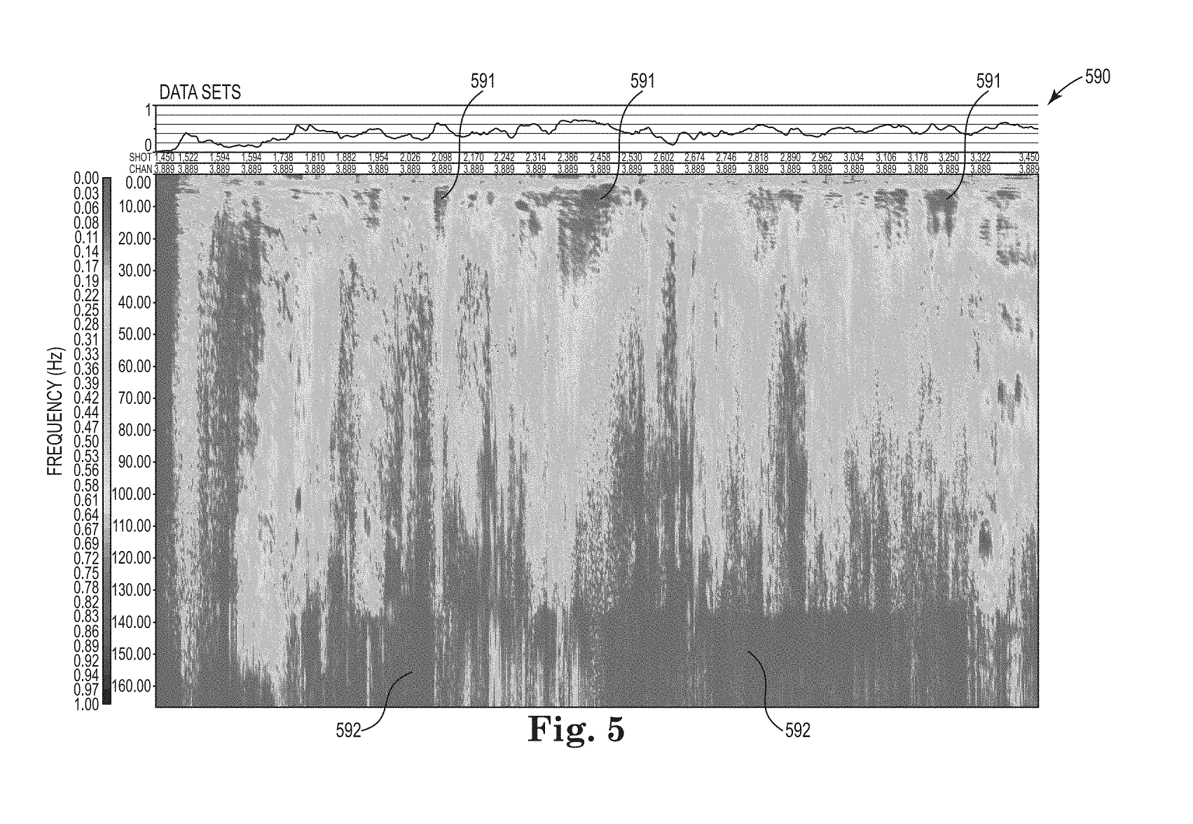

FIG. 4 illustrates a method flow diagram of a method 450 for a similarity determination based on a CF. In at least one embodiment, method 450 can be performed by a machine, such as machine 374 illustrated in FIG. 3. At 452, method 450 can include receiving a first set of seismic data and a second set of seismic data. In at least one embodiment, the first and the second sets of seismic data are indicative of a subterranean formation. For instance, the first and the second sets of seismic data may be recorded at receivers in response to source actuations occurring during a marine seismic survey. The first set of seismic data and the second set of seismic data can be compared using a CF. For instance, at 454, method 450 can include generating a CF using the first and the second sets of seismic data, and method 450, at 456 can include determining a similarity between the first and the second sets of the seismic data based on the generated CF. At 455, method 450 can include storing the received first and second sets of seismic data, the CF, a seismic model, or the determined similarity, for instance, in a data store as described with respect to FIG. 2. In at least one embodiment, the stored first and second sets of seismic data, CF, the seismic model, or determined similarity can be stored onshore or offshore.

In at least one embodiment, the first set of seismic data can include a set of seismic data comprising a set of seismic gathers of data containing primaries and multiples, and the second set of seismic data can include a set of seismic gathers of multiple models. In such an example, a similarity between the first and the second set of seismic gathers can indicate a good model. For instance, if the first set of seismic data is raw seismic data, and the second set of data includes a model or models of the first set of seismic data, similarities indicate the seismic models are accurate. In at least one embodiment, the second set of seismic data, which can include a multiple model or models can be a model of the multiples within the first seismic data set, and not a model of the first data set in its entirety. Dissimilarities can indicate errors in the seismic model, seismic data, or modeling process, among others.

In at least another embodiment, the first set of seismic data can include a set of seismic gathers of de-multipled data, and the second set of seismic data can include data set of seismic gathers containing adapted multiple models (or multiple models). For instance, the second set of seismic data can include an adapted multiple model that is subtracted from a data set including primaries and multiples to give the de-multipled data. In such an example, a similarity between the first and the second set of seismic gathers can indicate an issue with a de-multiple process. For instance, in an example where the second set of data includes multiples that were desired to be removed in a de-multiple process, similarities indicate the de-multiple process did not remove desired multiples. Accordingly, similarities can indicate errors in the de-multiple process or seismic data, among others. Dissimilarities can indicate multiples were removed, as they may not present in the second set of seismic data.

In yet another embodiment, the first set of seismic data can include a first multiple model, and the second set of seismic data can include a second multiple model. In such an example, if the first multiple model is a known good model, similarities between the first and the second set of seismic data can indicate the second multiple model is also a good model. Alternatively, a lack of similarities can indicate the second multiple model contains an error.

At 458, method 450 can include detecting a future error or absence of a future error associated with the first and the second sets of seismic data based on the determined similarity. A future error can include a mistake or incorrect condition that can reveal itself if not found in a current state. For instance, if issues are found in seismic data sets, a future error can be detected such that by adjusting a seismic data collection technique, a seismic data processing technique, a seismic data de-multiple technique, or other seismic data or process associated with the issue, an error can be prevented. For example, a bad seismic model can be fixed, and future seismic data may not be affected by the bad seismic model. In at least one embodiment, the future seismic data can be used to generate an image of a subsurface formation. That image may be better indicative of the subsurface formation than one generated by seismic data affected by the bad seismic model, for instance. Absence of a future error can include the lack of a mistake or incorrect condition that may reveal itself if not found in a current state. For instance, issues may bot be found or may be deemed negligible in seismic data sets such that an absence of a future error is detected.

Put another way, in at least one embodiment, by determining a quality of a plurality of multiple models based on the determined similarity, a future error in one of the plurality of multiple models can be avoided. Determining a quality of a plurality of multiple models, as used herein, includes determining a standard of the plurality of multiple models as measured against other models of a similar kind or a degree of excellence. For instance, improvements can be made to modeling techniques or particular multiple models can be used to detect and avoid future errors. Similar, in at least one embodiment, by determining a quality of a de-multiple process associated with the first and the second sets of seismic data based on the similarity, a future error in the process can be detected and avoided. Determining a quality of a de-multiple process, as used herein, includes determining a standard of the de-multiple process as measured against other processes of a similar kind or a degree of excellence. In at least one embodiment, a plurality of seismic models and their associated processes can be assessed to determine which of the models results in the least amount of errors. A performance indicator can used to make this determination, in at least one embodiment, and the performance indicator can be based on the CF-determined similarities. As used herein, a performance indicator can include a numerical measure that indicates a quality of a multiple model or a quality of the de-multiple process. A performance indicator can be used to compare different models or processes.

In at least one embodiment, a single set of seismic data can be compared to a plurality of different seismic models. For instance, if it is desired to assess a seismic model or model at a large plurality of locations (e.g., thousands of locations), at least one embodiment of the present disclosure can allow for determining similarities using a CF at each of the plurality of locations without having to assess each location independently. Put another way, the quality of a model at each of the plurality of locations can be determined without having to assess each location independently.

In at least one embodiment, the future error detection can be based on a phase portion or an amplitude portion of the CF with respect to frequency. For instance, similarities can be based on an amplitude portion of the CF, a phase portion of the CF, or both portions of the CF.

In at least one embodiment, the method 450 described with respect to FIG. 4 includes a process for detecting a future error associated with received sets of seismic data, wherein the method 450 is a specific improvement consisting of one or more of elements 452, 454, 455, 456, and 458. In at least one embodiment, the specific improvement can include detecting the future error to improve future seismic surveys and QC.

In accordance with at least one embodiment of the present disclosure, a geophysical data product may be produced or manufactured. Geophysical data may be obtained and stored on a non-transitory, tangible machine-readable medium. The geophysical data product may be produced by processing the geophysical data offshore or onshore either within the United States or in another country. If the geophysical data product is produced offshore or in another country, it may be imported onshore to a facility in the United States. Processing the geophysical data can include performing a full waveform inversion to determine a physical property of a subsurface location. In at least one embodiment, geophysical data is processed to generate a seismic image, and the seismic image on one or more non-transitory computer readable media, thereby creating the geophysical data product. In some instances, once onshore in the United States, geophysical analysis may be performed on the geophysical data product. In some instances, geophysical analysis may be performed on the geophysical data product offshore. For example, geophysical data can be obtained.

In at least one embodiment, having identified regions of a survey where issues may be present, plots of the amplitude portion or the phase portion of the CF with respect to frequency along a line in the region indicated by the maps can be examined to provide further information on a potential issue and to localize it. This potential issue and the maps can be used to detect a future error associated with the survey.

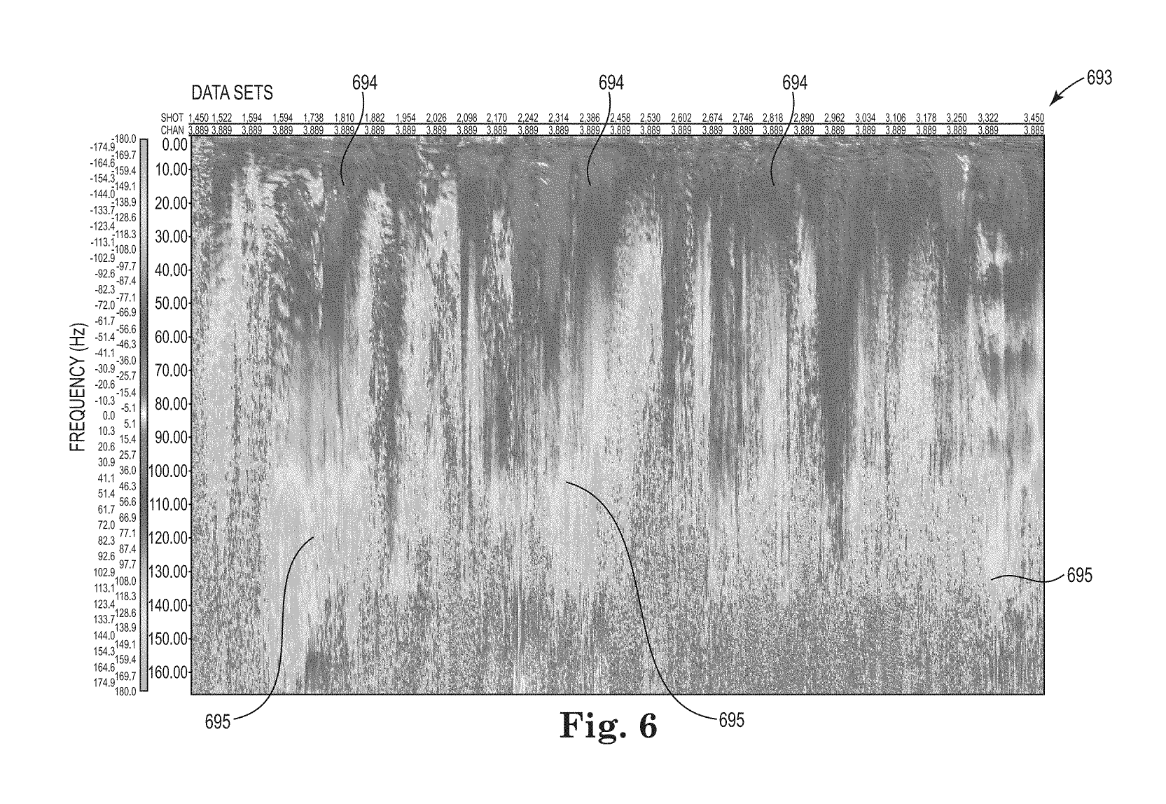

FIG. 5 illustrates a diagram 590 of an amplitude portion of a CF against frequency plotted along a two-dimensional (2D) processing line, for a set of data seismic gathers prior to de-multiple and a set of corresponding multiple model seismic gathers. Diagram 590 can indicate amplitude portion values which lie between zero and one. Example diagram 590 can indicate an RMS value of the amplitude portion in a 2-50 Hz frequency band. In this example, portions 591 can indicate higher CF values which can imply a good correspondence between data and model. The plots of CF along the line can be used to indicate individual seismic gathers of data where there may be issues.

In the example illustrated in FIG. 5, a CF has been calculated for two sets of data. The horizontal axis can represent individual pairs of data sets. For instance, along the horizontal axis can be different data sets being compared within a frequency range represented by the vertical axis of diagram 590. Portions 591 can indicate a CF amplitude portion near one and correspondingly similar data sets at the associated frequencies. In contrast, portions 592 can indicate a CF amplitude portion near zero and correspondingly dissimilar data sets at the associated frequencies.

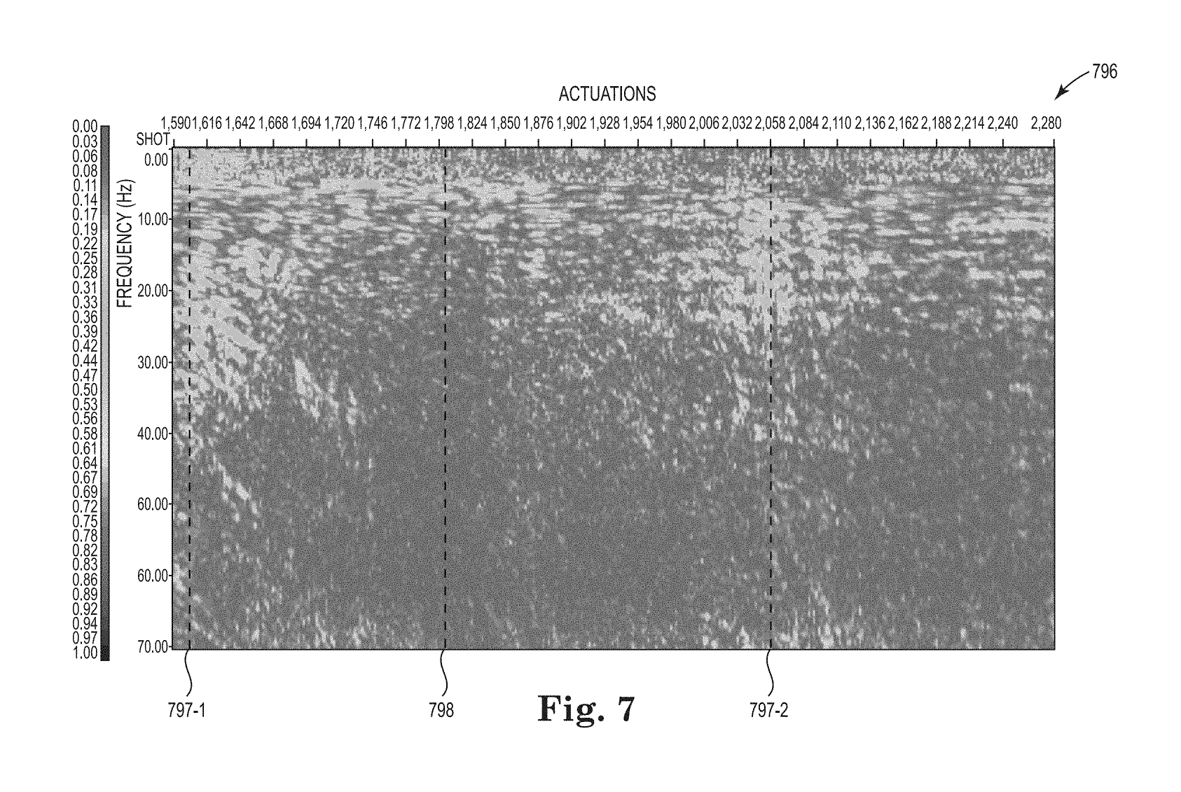

FIG. 6 illustrates a diagram 693 of a phase portion of the CF against frequency plotted along a 2D processing line, for a set of data seismic gathers prior to de-multiple and a set of corresponding multiple model seismic gathers. Diagram 693 can indicate the phase portion values of the CF which lie in the range of −180 to +180 degrees. For example, the horizontal axis of diagram 693 can include individual data sets lying in the range of −180 to +180 degrees within a frequency range represented by the vertical axis of diagram 693. Portions 694 can indicate a CF phase portion near zero and correspondingly in phase portion data sets at the associated frequencies. In contrast, portions 695 can indicate a CF amplitude near −180 or +180 and correspondingly out of phase portion data sets at the associated frequencies.

FIG. 7 illustrates a diagram 796 of an amplitude portion of a CF against frequency plotted along a 2D processing line for a set of data seismic gathers after de-multiple and the set of corresponding adapted multiple model seismic gathers which were subtracted from the initial data prior to de-multiple. Diagram 796 can indicate CF amplitude portion values which lie between zero and one. The horizontal axis can represent individual actuations corresponding to different sets of physical data including, for example, shot gathers, receiver gathers, common channels, etc. For instance, along the horizontal axis can be different actuations being compared within a frequency range represented by the vertical axis of diagram 796. In diagram 796, portions 797-1 and 797-2 can represent CF amplitude portion values closer to one, which in at least one embodiment, can imply there may be residual multiple or primary leakage. Portion 798 can imply there may be reduced or no multiple or primary leakage.

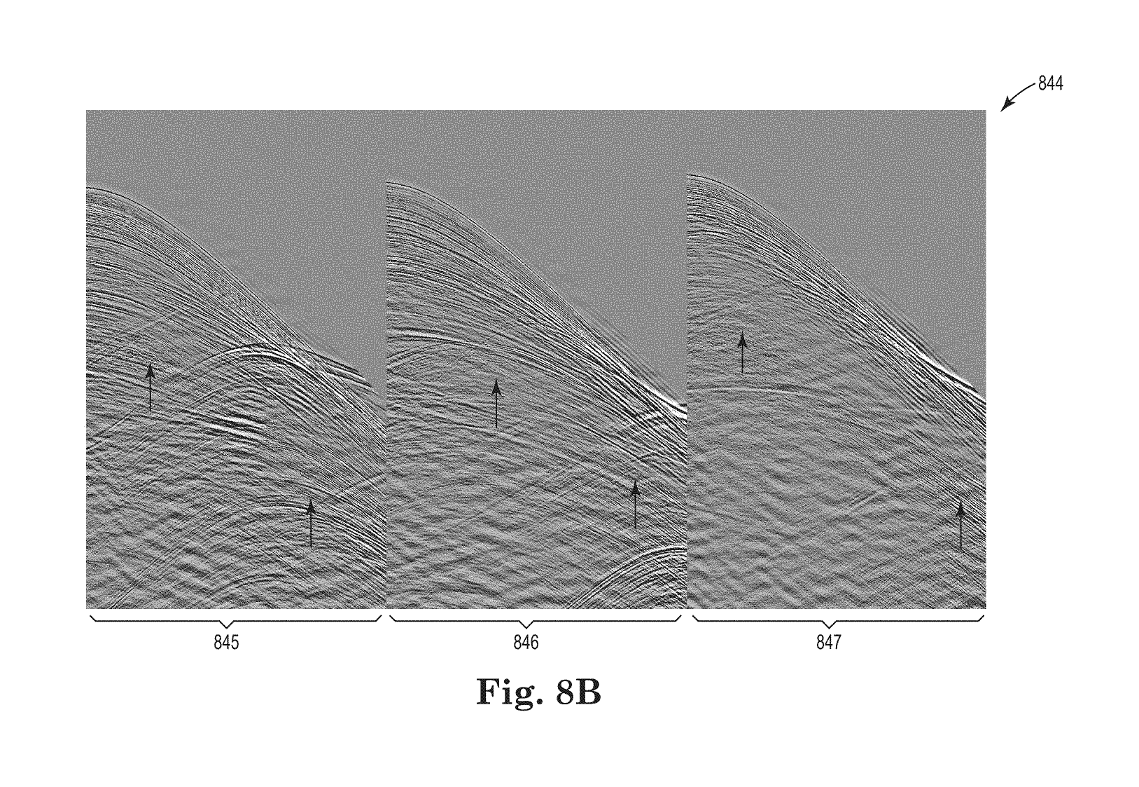

FIG. 8A illustrates a diagram 840 of seismic gathers 841, 842, 843 prior to de-multiple corresponding to the portions 797 an 798 indicated in FIG. 7. Seismic gathers 841, 842, 843 can be seismic shot gathers, for example. In response to de-multiple, the values of the CF can predict issues with residual multiple that may be likely in the seismic gather 841, the second seismic gather 842 can illustrate desirable de-multiple results, and the third seismic gather 843 can include issues to a lesser extent than the first seismic gather 841.

FIG. 8B illustrates a diagram 844 of seismic gathers 845, 846, 847 after de-multiple corresponding to the seismic gathers 841, 842, 843 in FIG. 8A, respectively. Seismic gathers 845, 846, 847 can be seismic shot gathers, for example. In response to de-multiple, as the values of the CF indicated in diagram 844, there can be issues with residual multiple in the first seismic gather 845, the second seismic gather 846 can illustrate desirable de-multiple results, and the third seismic gather 847 can illustrate issues to a lesser extent than the first seismic gather 845.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
receiving a first set of seismic data and a second set of seismic data;
generating a coherence function using the first and the second sets of seismic data;
storing the coherence function;
determining a similarity between the first and the second sets of the seismic data based on the generated coherence function; and
detecting a future error or the absence of a future error associated with the first and the second sets of seismic data based on the determined similarity.

2. The method of claim 1, wherein receiving the first and the second sets of seismic data comprises receiving the first set of seismic data comprising a set of seismic gathers of data containing primaries and multiples and the second set of seismic data comprising a set of seismic gathers of multiple models.

3. The method of claim 1, further comprising determining a quality of a plurality of multiple models based on the determined similarity.

4. The method of claim 1, further comprising determining a quality of a de-multiple process associated with the first and the second sets of seismic data based on the determined similarity.

5. The method of claim 1, wherein receiving the first and the second sets of seismic data comprises receiving the first set of seismic data comprising a set of seismic gathers of de-multipled data and the second set of seismic data comprising a set of seismic gathers of adapted multiple models.

6. The method of claim 1, further comprising detecting the future error based on a phase portion of the coherence function with respect to frequency.

7. The method of claim 1, further comprising detecting the future error based on an amplitude portion of the coherence function with respect to frequency.

8. The method of claim 1, wherein receiving the first and the second sets of seismic data comprises receiving the first set of seismic data comprising a first multiple model and the second set of seismic data comprising a second multiple model.

9. A system, comprising:
a first receipt engine configured to receive a set of seismic gathers of multiple models;
a second receipt engine configured to receive a set of seismic gathers of de-multipled data;
a coherence engine configured to generate a coherence function using the set of seismic gathers of multiple models and the set of seismic gathers of de-multipled data and including a phase portion and an amplitude portion of the coherence function; and
a determination engine configured to determine a similarity between the set of seismic gathers of multiple models and the set of seismic gathers of de-multipled data based on the generated coherence function.

10. The system of claim 9, wherein the set of seismic gathers of multiple models comprise raw multiple models.

11. The system of claim 9, wherein the set of seismic gathers of multiple models comprise models adapted to seismic data.

12. The system of claim 9, wherein the set of seismic gathers of de-multipled data comprises models of seismic data subsequent to adaptive subtraction of a multiple model.

13. The system of claim 9, further comprising an adjustment engine configured to adjust a parameterization of an associated adaptive subtraction of the multiple model using the generated coherence function.

14. A non-transitory machine-readable medium storing instructions executable by a processing resource to:
generate a coherence function for a first set of seismic gathers comprising seismic data containing primaries and multiples and a second set of seismic gathers comprising multiple models over a seismic survey;
split the generated coherence function into a phase portion and an amplitude portion;
generate a plurality of root mean square (RMS) values over a predetermined frequency range based on the amplitude portion;
determine a dissimilar portion of seismic data gathered during seismic survey based on the RMS values and the amplitude portion; and
remove the dissimilar portion from the seismic data.

15. The medium of claim 14, wherein the instructions executable to remove the dissimilar portion comprises instructions executable to automatically narrow down the dissimilar portion to an individual gather prior to removal.

16. The medium of claim 14, further comprising instructions executable to split the generated coherence function into a phase portion indicating a time shift between the first set of seismic gathers and the second set of seismic gathers and an amplitude portion indicating a similarity between the first set of seismic gathers and the second set of seismic gathers.

17. The medium of claim 14, wherein first set of seismic gathers comprises a base set of gathers and the second set of seismic gathers comprises a monitor set of gathers.

18. The medium of claim 14, further comprising instructions executable to adaptively subtract the second set of seismic data from the first set of seismic data using the coherence function as a set of data weights as a numerical measure of quality of the second set of seismic data.

19. A method to manufacture a geophysical data product, the method comprising:
obtaining geophysical data, wherein obtaining the geophysical data comprises receiving a first set of seismic data and a second set of seismic data;
processing the geophysical data, comprising:
generating a coherence function using the first and the second sets of seismic data;
storing the coherence function;
determining a similarity between the first and the second sets of the seismic data based on the generated coherence function; and
detecting a future error or absence of a future error associated with the first and the second sets of seismic data; and
recording the geophysical data product on one or more non-transitory machine-readable media, thereby creating the geophysical data product.

20. The method of claim 19, wherein processing the geophysical data comprises processing the geophysical data offshore or onshore.
